(19) United States
(12) Patent Application Publication
(10) Pub. No.: US 2008/0196766 A1
(43) Pub. Date: Aug. 21, 2008

(54) Breakaway self-sealing safety valve

(76) Inventor: Wilber Ross Gandy, Florence, SC (US)

Correspondence Address: WILBER ROSS GANDY, 2436 WATERFRONT DR, FLORENCE, SC, 29501, US

(21) Appl. No.: 11/708,870

(22) Filed: Feb. 21, 2007

(51) Int. Cl. F16K 17/40; F16K 1/00

(52) U.S. Cl. 137/68.14

(57) ABSTRACT

A valve safety device comprised of the valve receiver (12) and the valve connector (11), made of high-strength metal is connected to a standard dispensing valve used on high-pressure containers, tanks or oil wells. Upon damage to the valve, the safety device breaks at a pre-determined location (40), allowing the plunger (10) to disengage, which releases the ball (13), normally held in place by the spring (14), allowing the ball (13) to close the dispensing hole, preventing the contents from escaping. Continued use of the container is quickly accomplished by screwing in a new safety device top (12), which pushes the plunger (10) into the ball (13), again allowing for free flow of the contents when the dispensing valve is operated.

### CROSS-REFERENCE TO RELATED APPLICATIONS

| | | |
|---|---|---|
| 4067354 | January, 1978 | St. Clair |
| 4562852 | January, 1986 | Britt |
| 4606367 | August, 1986 | Britt |
| 5103860 | April, 1992 | Morris |
| 5269352 | December, 1993 | Gold |
| 5638858 | June, 1997 | Gettinger, et al |
| 6003714 | December, 1999 | Buermann |
| 6209749 | April, 2001 | Guess |
| 6955194 | October, 2005 | MacNeal, et al |

### FEDERALLY SPONSORED RESEARCH

Not applicable

### SEQUENCE LISTING OR PROGRAM

Not applicable

### BACKGROUND OF THE INVENTION

1. Field of Invention

The Breakaway Self-Sealing Safety Valve relates to the protection and stabilization of valves used on high-pressure containers for the storage and dispensing of various gases, liquids and chemicals, and the containment of the contents when the valve is broken.

2. Prior Art

Examples of prior art combination safety and service valves, in which such safety means are utilized, are shown in U.S. Pat. Nos. 4,562,852 and 5,103,860. The valves described in each of the referenced patents are part of the valve itself and include similar sealing mechanisms. These units have several distinct disadvantages:
(a) Because these units are a part of the valve itself they cannot be incorporated into many existing valves because of design differences between the device and the valve.
(b) With the prior design, if the valve is broken off, the contents of the container must be removed before the valve can be replaced, which eliminates that specific container from use for some time.
(c) Removal of the contents after a valve breakage with the prior design in place, cannot be accomplished in the field or in many enclosed locations, so the container has to be relocated to an area that can be used for ventilating its contents or transferring the contents to another container.
(d) Since the possibility of repair or retrofit of the valve when using the prior designs cannot take place until the contents have been exhausted, this eliminates the possibility of repair or retrofit in the field.
(e) Similar devices are relatively complicated to construct and awkward to use because they are a part of the valve itself and would have to be constructed as the valve is being constructed.
(f) Some prior designs merely surround the valves, creating a barrier of sorts around the valve. This serves only as a ring of protection against normal bumps and wear and tear of valves on these containers, not as a protection of the contents in case of valve breakage or rupture.
(g) The prior designs are created for gas containers only, and are not used for chemical containers, liquid or steam containers or for oil well valve security.
(h) The extreme pressure in the containers prevents the prior designs from being removed when the valve breaks until all contents have been expelled or removed.
(i) The possibility of chemical or gas exposure prevents the valve from being replaced once it is ruptured once the prior design closes off the contents.

Further objects and advantages will become apparent from a consideration of the ensuing description and drawings.

### BACKGROUND OF THE INVENTION—OBJECTS AND ADVANTAGES

Accordingly, several objects and advantages of the Breakaway Self-Sealing Safety Valve are:
(a) to provide instant sealing to a broken valve, which can effectively protect and maintain the contents of high pressure gas containers, hazardous chemicals or other liquids in containers or in pressurized oil well pumps, as well as protecting person and property surrounding said containers.
(b) to provide a safety device that can be economically retrofitted on existing valves in any environment with safety and ease.
(c) to provide an economical means for repairing damaged or broken valves in the field, without emptying the container or using special tools.
(d) to eliminate the threat of sabotage by the use of this device on containers where valves can be intentionally broken off for the purpose of allowing hazardous chemicals or gases to escape, thereby contaminating air, water, humans and all it touches.
(e) to further eliminate the threat of sabotage by the use of this device on containers where valves can be intentionally broken off for the purpose of allowing a pressurized container to become an airborne missile, carrying not only its contents, which could be explosive, hazardous or flammable, but the container could be strapped with explosives or other devices to create additional damage to person and property when it lands.
(f) to support in the protection of oil wells, which can come under attack during times of hostilities, by providing a instantly sealing device for valves that may be broken or damaged, allowing the oil or gas to escape, resulting in loss of fuels and the possibility of uncontrollable fires.
(g) to support in the protection of oil wells in normal oil drilling environments, where the possibility of valve rupture or accidental breakage may occur.

Further objects and advantages will become apparent from a consideration of the ensuring description and drawings.

### SUMMARY

The Breakaway Self-Sealing Safety Valve is a device that is placed between a valve and a high-pressure container, which allows the valve to perform like any other high-pressure gas valve, while the device provides security and safety. If the valve is struck or the gas bottle is dropped on the valve, instead of the valve rupturing and the contents escaping to pollute the surroundings, or the high-pressure gas container becoming a missile, propelled by its own contents, the Breakaway Self-Sealing Safety Valve instantly seals the valve, protecting the surroundings and saving the contents.

### DRAWINGS—FIGURES

FIG. 1A is a standard oxy-acetylene cutting setup with a high-pressure oxygen bottle.

FIG. 2A-2C shows the individual machined parts of the device

FIG. 3A-3D shows the assembly of the device

FIG. 4A-4C shows how the device is attached to the valve and how it works

FIG. 5A-5E shows how the old or damaged valve portion of the assembly can be removed and a new piece connected without disturbing the contents of the bottle or container

### DRAWINGS—REFERENCE NUMERALS

10 plunger
11 valve connector
12 valve receiver
13 sealing device
14 spring
15 retainer
20 washer (optional)
30 valve
40 breakaway groove
41 high-pressure gas bottle
50 bottle cap

### DETAILED DESCRIPTION OF THE INVENTION

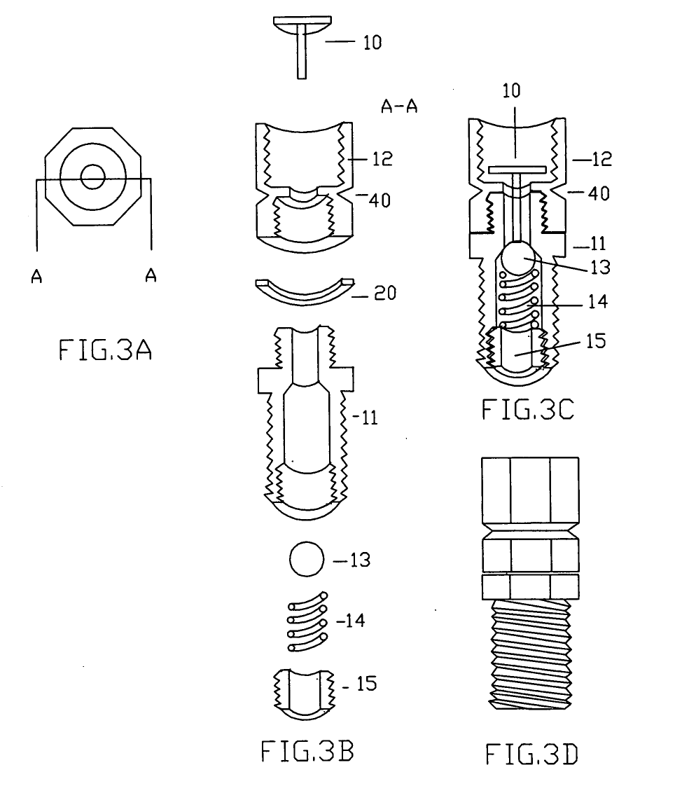

A preferred embodiment of the Breakaway Self-Sealing Safety Valve is illustrated in FIG. 3D—Side View and 4A—Cut-away View. The valve is made in two sections. One section is the breakaway section of the Breakaway Self-Sealing Safety Valve. The second attaches to the container and houses the sealing ball and spring.

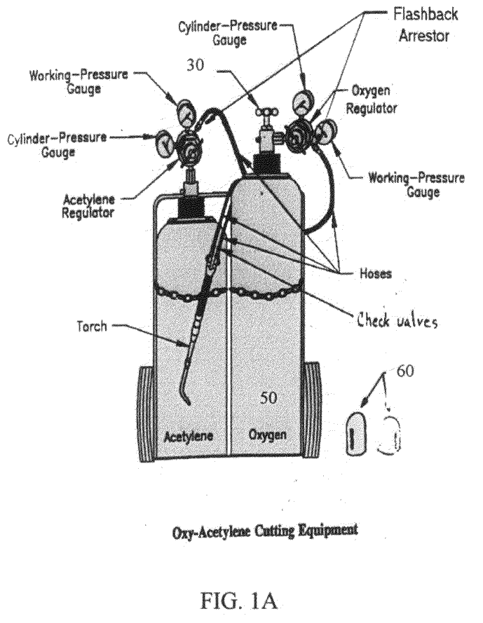

FIG. 1A illustrates an example of the use of a valve on a container of high-pressure pressure gas. This is a typical cart-held, oxy-acetylene gas, cutting unit, which contains a high-pressure oxygen bottle (50) and a valve (30). The cylinder cap (60) is used to protect the high-pressure oxygen bottles while they are being transported. Very often, the cart is moved without replacing the cap (60). This creates an opportunity for the cart to be dropped or turned over, or the valve to be struck and broken. If the valve is cracked or broken, the gas will escape at a tremendous speed and the bottle and possibly the entire cart can be propelled like a missile, potentially causing great damage and even injury or death.

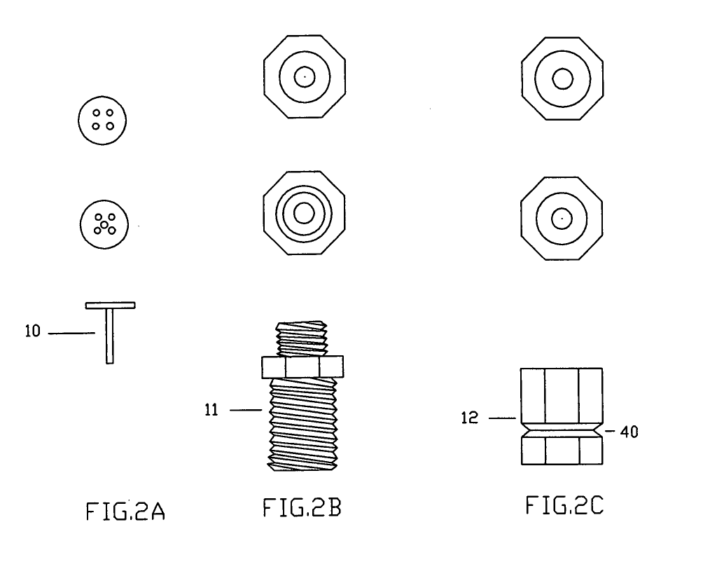

FIG. 2A-2C illustrate the machined components of the Breakaway Self-Sealing Safety Valve for a typical high-pressure gas valve. This same design can be used for hazardous chemical containers as well as steam lines or oil wells. FIG. 2A shows part 10, which is the plunger, containing holes through which the gas or fluid will pass. FIG. 2B shows part 11, which is the connector. This part screws into the bottle or container and houses the self-seal components. FIG. 2C shows the valve receiver (12), which holds the valve and the plunger (10). FIG. 2C also illustrates the breakaway groove (40), which is set at a predetermined breaking point. Parts 11 and 12 are machined from hex brass stock for strength and protection against contamination. The dimensions of parts 10, 11, and 12 will vary depending on the size and the use of the valve for which it is used.

FIG. 3A-3D illustrates the assembly of the device. FIG. 3A shows the top view of the device and its cross section. FIG. 3B shows the arrangement of the parts and their sequence of assembly. The valve receiver (12) is connected to the connector (11) by screwing the smaller male end of the connector (11) into the smaller female end of the valve receiver, with the optional washer (20) placed between the two components (11 & 12). The ball (13) is inserted into the opening in the base of the connector (11) followed by the spring (14) and then the retainer (15). The retainer (15) is screwed into the female opening in the base of the connector (11) and applies tension against the spring (14), which applies pressure against the ball (13), which seals the exit hole in the top of the connector (11). The retainer (15) has a corresponding exit hole to allow for the flow of the gas or fluid from the bottle or container. The plunger (10) is inserted into the opening in the top of the valve receiver (12) and through the exit hole in the bottom of the valve receive (12) which corresponds to the exit hole in the top of the connector (11). FIG. 3C shows the assembled device after all components are assembled. It shows how the ball (13) is held tightly against the exit hole in the connector (11). FIG. 3D shows the assembled device without the cut-away. The male end at the bottom of the assembled device is then ready to screw into the corresponding female threads of the gas bottle or fluid container.

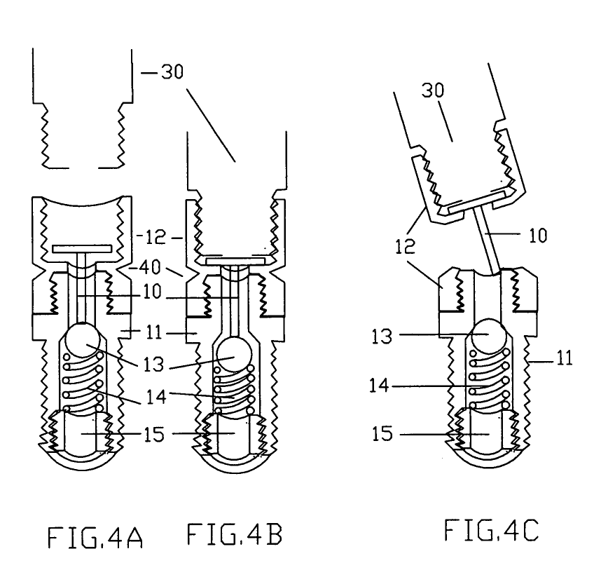

FIG. 4A-4C illustrate the proper assembly of the valve (30) and the device. FIG. 4A shows the proper alignment of the valve (30) and the device prior to the assembly. It shows the position of the ball (13) and spring (14) as the ball (13) is held tightly against the exit hole in the connector (11). The plunger (10) sits on top of the ball (13) but does not disturb the ball (13). FIG. 4B shows that when the valve (30) is connected to the device, it forces the plunger (10) down against the ball (13), which forces the ball (13) away from the exit hole between the connector (11) and the valve receiver (12), allowing for the gas or fluid to flow through the valve (30). As long as the valve (30) is connected to the device, the device will remain open and the contents of the container can flow freely when the valve (30) is opened. FIG. 4C shows the effect of the valve being broken away. When struck, the valve/device assembly will break at the pre-determined breakaway point (40), which releases the pressure on the ball (13) by taking away the plunger (10) which remains with the valve (30). The ball (13) instantly seals the opening and is held in place by the spring (14) and the pressure of the gas or fluid in the container, and the contents remains safely in the container.

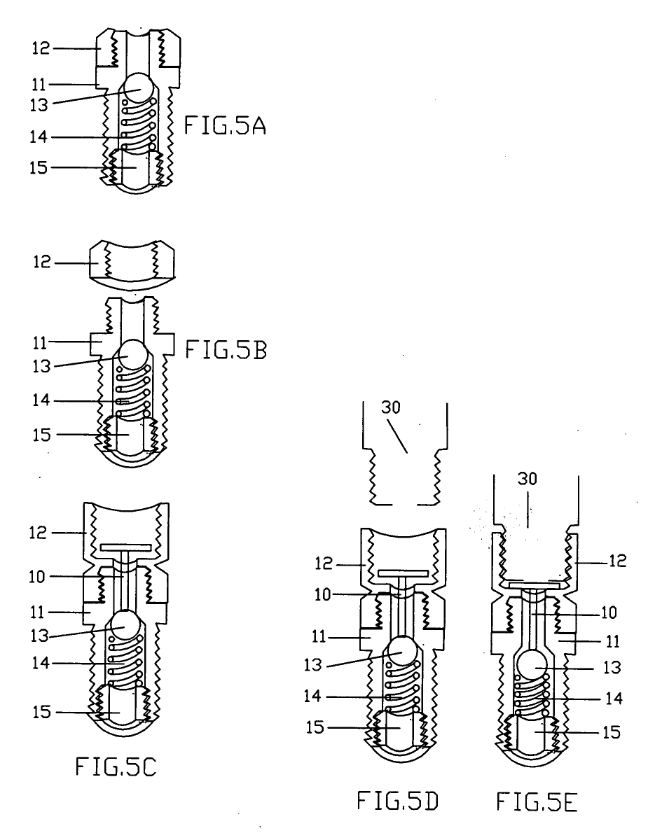

FIG. 5A-5E illustrate how the damaged device can be repaired without disturbing the contents of the container or endangering anyone around the container. FIG. 5A shows the part of the device that remains attached to the container and illustrates that the exit hole is sealed. FIG. 5B shows how the damaged portion part (12) is removed. The device remains sealed and the contents of the bottle or container remain safe. FIG. 5C shows the device with a new valve receiver (12) installed on the connector (11) and a new plunger installed in the valve connector (12) without disturbing the ball (13) or the contents of the bottle or container. FIG. 5D shows the alignment of the new valve (30) and the valve receiver (12). FIG. 5E shows that when the valve (30) is installed or screwed into the valve receiver (12), it makes contact with the plunger (10) and forces it down against the ball (13) pushing it away from the exit hole, which allows the gas or fluid to flow out of the container once the valve (30) is opened.

### Advantages

From the above description, a number of advantages of my Breakaway Self-Sealing Safety Valve become evident:
a. The Breakaway Self-Sealing Safety Valve fitted to High-pressure gas or liquid containers for transportation, eliminate the danger of explosion, contamination and/or injury due to rupture of the valve if the container falls or is struck and the valve is broken, by immediately sealing the container.
b. A valve rupture can be immediately repaired, without removing the contents of the container with the Breakaway Self-Sealing Safety Valve, saving the cost of replacing the contents.
c. Because a high-pressure container valve can be repaired anywhere, if it contains the Breakaway Self-Sealing Safety Valve, there is no expense for removing the container from its present use, transportation to relocate it for repairs or downtime to replace it.
d. The Breakaway Self-Sealing Safety Valve prevents loss of contents into the air or onto property or humans by immediately sealing the container, thereby reducing or eliminating potential risk to the environment, property or human life.
e. The potential for sabotage or intentional destructive use of high-pressure containers as weapons is eliminated or lessened. The valve on a high-pressure container can be intentionally broken and the container pointed in a specific direction to be driven by the pressure of the escaping gas or liquid. The Breakaway Self-Sealing Safety Valve seals a ruptured valve immediately, preventing the container from becoming a high-speed projectile, either potentially exploding because of its own contents, or by carrying explosives, biohazards or other weaponry on the tank.
f. Both in the U.S. and abroad, oil wells are subject to terrorist attack and/or intentional destruction. Fires, explosions and oil loss from these attacks could be eliminated or minimized by ensuring that every oil well valve is fitted with a Breakaway Self-Sealing Safety Valve to seal the well line in case of damage to the valves controlling the flow of crude oil. In addition to the safety issues, the containment of the crude oil could save millions of dollars as well as protect the surrounding environment.

### Conclusion, Ramifications and Scope

Accordingly, the reader will see that the Breakaway Self-Sealing Safety Valve can be used to not only protect containers of hazardous chemicals and high pressure gas bottles from accidental damage which can cause serious harm to property and life, it can also be used to protect against the use of these containers as potential weapons by saboteurs or terrorists both in the U.S. and abroad. Furthermore the Breakaway Self-Sealing Safety Valve has the additional advantages in that
it provides a new safety device for use on high-pressure gas bottles and other containers of liquids, hazardous chemicals, steam or oil.
it provides an economical safety device that can be retrofitted on existing valves eliminating the need for special valves.
it allows for repair of damaged or broken valves without having to empty the contents of the container
it allows for repair of damaged or broken valves in the field quickly and economically without the need for special tools or devices.
it lessens the possibility of saboteurs or terrorists, either in the U.S. or abroad, breaking off tank or container valves, allowing hazardous chemicals, liquids or gases to escape, contaminating air, water and all it touches.
it makes oil wells more difficult to sabotage by immediately sealing off pump valves that are broken, whether intentionally or accidentally. This will eliminate resulting oil fires, which are extremely difficult to contain, and preserve the crude oil or gas that normally escapes during this kind of damage, lessening economic impacts.

Although the description above contains many specifics, these should not be construed as limiting the scope of the Breakaway Self-Sealing Safety Valve but merely providing illustrations of some of the presently preferred embodiments. Thus the scope of the Breakaway Self-Sealing Safety Valve should be determined by the appended claims and their legal equivalents, rather than by the examples given.

I claim:

1. A self-sealing safety device made as a two-part unit inserted between a dispensing valve and a high-pressure container of gas, liquid or steam, will stop the flow of contents in the event the valve is broken off.
1. The size of said self-sealing safety device of claim 1 is determined by the size of said dispensing valve and said container.
2. Said dispensing valve and the corrosive property of said container determine the material used to make said self-sealing device of claim 1.
3. Said self-sealing device of claim 1 has a body comprising:
a. a valve receiver to screw onto said dispensing valve, with an exit hole through the center means to allow the flow of said contents of said container, and
b. a sealing mechanism embodiment that screws onto said valve receiver and into said container with an exit hole corresponding with said hole in said valve receiver means to allow the flow of said contents of said container, and
c. the sealing mechanism, comprised of a sealing ball or similar device held in place by a spring or similar device and housed in said sealing mechanism embodiment means to seal said exit hole.
d. a plunger inserted into the female end of the body means to apply pressure to said sealing mechanism to keep said
e. sealing ball or similar device pushed away from said exit hole so said
f. contents can flow unrestricted through said dispensing valve, once the dispensing valve is screwed into said female end of said self-sealing device of claim 1.
g. a pre-determined breaking point on said self-sealing device means to allow said plunger to release the pressure on said sealing device.
h. The body of said self-sealing device of claim 1 can be separated at any time without the loss of said contents, once it is screwed into said container.
Whereby, in the event said dispensing valve is broken away, said container is sealed and said contents contained. Said self-sealing device of claim 1 can be repaired and said contents of said container used without danger of injury or contamination to personnel, property or the environment.
